(19) United States
(12) Patent Application Publication
(10) Pub. No.: US 2026/0316816 A1
(43) Pub. Date: Oct. 15, 2026

(54) STEERING-OPERATION INPUT MEMBER, STEERING-OPERATION INPUT DEVICE, AND STEERING APPARATUS

(71) Applicant: Hitachi Astemo, Ltd., Ibaraki (JP)

(72) Inventors: Yusuke AMMA, Ibaraki (JP); Takafumi OJIO, Ibaraki (JP); Jun SAKAKI, Ibaraki (JP); Norio KIKUCHI, Ibaraki (JP)

(21) Appl. No.: 19/102,095

(22) PCT Filed: Nov. 30, 2023
(86) PCT No.: PCT/JP2023/042901

§ 371 Date: Feb. 7, 2025

(30) Foreign Application Priority Data
Dec. 5, 2022 (JP) 2022-193901

(51) Int. Cl. B62D 1/04

(52) U.S. Cl. CPC B62D 1/04; G05G 1/08

(57) ABSTRACT

Provided are a steering-operation input member, a steering-operation input device, and a steering apparatus, which enable improvement of operability. The steering-operation input member includes: a shaft configured to be rotated about an axis thereof; a dial provided to the shaft; and a first arm and a second arm, which are connected to the shaft and each have a different length from a rotation center of the shaft with respect to the dial.

### TECHNICAL FIELD

The present invention relates to a steering-operation input member, a steering-operation input device, and a steering apparatus.

### BACKGROUND ART

In Patent Literature 1, there is disclosed a dial type steering device that can be rotationally operated by a driver using one hand.

### CITATION LIST

### Patent Literature

PTL 1: JP 2020-172135 A

### SUMMARY OF INVENTION

### Technical Problem

In the related art described above, however, a driver is required to perform an operation for the entire steer angle range only through a dial operation. Thus, operability is required to be improved.

One object of the present invention is to provide a steering-operation input member, a steering-operation input device, and a steering apparatus, which enable improvement of operability.

### Solution to Problem

A steering-operation input member according to one embodiment of the present invention includes: a rotary shaft configured to be rotated about an axis thereof; a first operating portion provided to the rotary shaft; and a second operating portion, which is connected to the rotary shaft and has a different length from a rotation center of the rotary shaft with respect to the first operating portion.

Thus, according to one embodiment of the present invention, a driver can perform an operation by using either the first operating portion or the second operating portion depending on the operation. Thus, operability can be improved.

### BRIEF DESCRIPTION OF DRAWINGS

FIG. 1 is a schematic diagram of a steering apparatus (1) according to a first embodiment.

FIG. 2 is a perspective view of a steering-operation input member (2) according to the first embodiment when viewed from the right rear of a vehicle.

FIG. 3 are views for illustrating a method of operating the steering-operation input member (2) according to the first embodiment.

FIG. 4 is a view of a steering-operation input member (2) according to a second embodiment when viewed from above.

FIG. 5 is a perspective view of a steering-operation input member (2) according to a third embodiment when viewed from the right rear of a vehicle.

FIG. 6 is a perspective view of a steering-operation input member (2) according to a fourth embodiment when viewed from the right rear of a vehicle.

FIG. 7 is a perspective view of a steering-operation input member (2) according to a fifth embodiment when viewed from the right rear of a vehicle.

### DESCRIPTION OF EMBODIMENTS

### First Embodiment

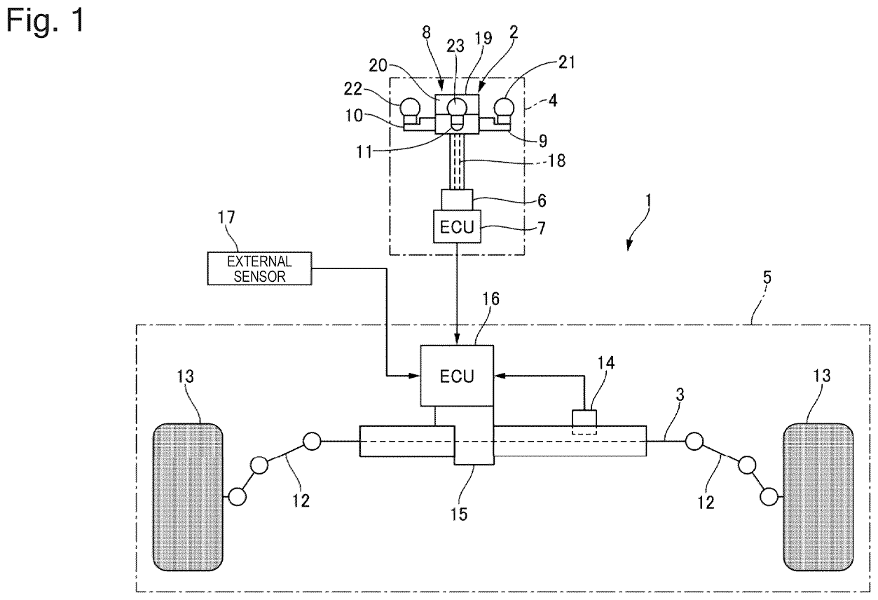

FIG. 1 is a schematic diagram of a steering apparatus 1 according to a first embodiment.

The steering apparatus 1 according to the first embodiment is a so-called steer-by-wire steering apparatus in which a steering-operation input member 2 and a rack bar (turning shaft) 3 are mechanically separated from each other.

The steering apparatus 1 includes a steering-operation input device 4 and a turning device 5.

The steering-operation input device 4 includes the steering-operation input member 2, a steering-angle sensor 6, and a steering ECU (output unit) 7.

A steering operation performed by a driver is input to the steering-operation input member 2. The steering-operation input member 2 includes a dial 8, a first arm 9, a second arm 10, a small steer-angle adjustment arm 11, and a rotary shaft (hereinafter referred to as “shaft 18”). The dial 8 or the small steer-angle adjustment arm 11 corresponds to a first operating portion that is subjected to a steering operation when a first steer angle is to be applied to front wheels 13. Meanwhile, the first arm 9 and the second arm 10 correspond to a second operating portion that is subjected to a steering operation when a second steer angle larger than the first steer angle is to be applied to the front wheels 13. A specific configuration of the steering-operation input member 2 is described later. The steering-angle sensor 6 detects a steering angle (operation amount) of the steering-operation input member 2, specifically, a rotation angle of the steering-operation input member 2. The steering ECU 7 outputs a turning command based on the steering angle detected by the steering-angle sensor 6 to a turning ECU 16 of the turning device 5, which is described later. The turning command is, for example, a value proportional to the steering angle of the steering-operation input member 2.

The turning device 5 includes the rack bar 3, tie rods 12, the front wheels (wheels) 13, a rack-bar position sensor 14, a turning motor (turning actuator) 15, and the turning ECU 16. The rack bar 3 is movable in a vehicle width direction, and turns the front wheels 13 through intermediation of the tie rods 12 in accordance with the amount of movement. The rack-bar position sensor 14 detects a position of the rack bar 3, and outputs a turning-angle signal in accordance with the detected position to the turning ECU 16. A steer angle (turning angle) of the front wheels 13 is uniquely determined in accordance with the position of the rack bar 3. Thus, the turning-angle signal is a signal related to the steer angle of the front wheels 13. The turning motor 15 applies a thrust force to the rack bar 3 based on a drive command from the turning ECU 16.

The turning ECU 16 generates the drive command for driving the turning motor 15 based on the turning command and various signals from an external sensor 17, and outputs the generated drive command to the turning motor 15. The external sensor 17 is, for example, a vehicle-velocity sensor, and performs correction so as to reduce the turning command as a vehicle velocity increases.

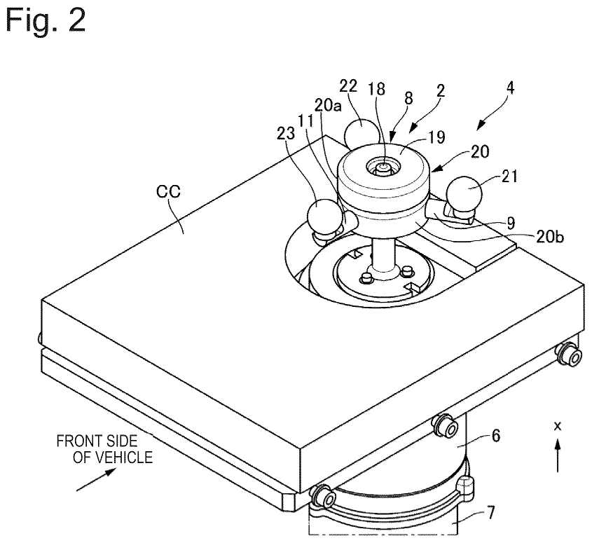

Next, referring also to FIG. 2, a configuration of the steering-operation input device 4 is described in detail. FIG. 2 is a perspective view of the steering-operation input member 2 according to the first embodiment when viewed from the right rear of a vehicle.

The steering-operation input member 2 according to the first embodiment is installed in a center console CC. The dial 8 has an axis parallel to the shaft 18 extending in a vertical direction, and rotates about the axis. Hereinafter, an x axis is set to extend in a direction along the shaft 18, a vertically upward x-axis direction is referred to as “x-axis positive direction”, and a vertically downward x-axis direction is referred to as “x-axis negative direction”. Further, a radiation direction with respect to the shaft 18 is referred to as “radial direction”, and a direction around the shaft 18 is referred to as “circumferential direction”.

The dial 8 is provided to the shaft 18, and is formed into a bottomed cylindrical shape. The dial 8 has a placement portion 19 and a side surface portion 20. The placement portion 19 expands radially outward from the shaft 18, and allows a hand of the driver to be placed thereon. The placement portion 19 is formed flat, and has a diameter of, for example, 50 mm. The side surface portion 20 extends in the x-axis negative direction from a radially outer side of the placement portion 19. The side surface portion 20 is divided into two, i.e., an upper member 20a and a lower member 20b, in the x-axis direction. The upper member 20a and the lower member 20b of the side surface portion 20 are both rotated integrally with the shaft 18. The dial 8 may be formed integrally with the shaft 18. The first arm 9 and the second arm 10 are connected to the shaft 18, and extend radially outward from the lower member 20b. The first arm 9 and the second arm 10 have the same shape. The first arm 9 and the second arm 10 may be connected to the shaft 18 through intermediation of the lower member 20b as in the first embodiment, or may be connected to the shaft 18 without intermediation of the lower member 20b.

The first arm 9 and the second arm 10 are arranged so as to be located at bilaterally symmetric positions with respect to the dial 8 when the dial 8 is in neutral position. The neutral position of the dial 8 is a rotational position of the dial 8 when the vehicle is running straight ahead, that is, a rotational position corresponding to a zero steer angle of the front wheels 13. A play (steering dead zone) of several degrees may be set on each of the right and left sides of the neutral position of the dial 8. The steering-operation input member 2 is constantly urged toward the neutral position. Specifically, when the driver operates the steering-operation input member 2, a steering reaction force is always generated. As means of generating the steering reaction force (urging force), a motor or a spring may be used. The steering-operation input member 2 is rotatable by about 180° to each of the right side and the left side from the neutral position. The front wheels 13 each have a maximum steer angle (maximum turning angle) when the rotation angle of the steering-operation input member 2 is maximum (≈180°). Here, regarding the first steer angle and the second steer angle described above, in a case in which, for example, the steering dead zone is set, the first steer angle is a steer angle by which the front wheels 13 are actually turned through the rotation of the dial 8 beyond the steering dead zone. This corresponds to a case in which the dial 8 is rotated by a small angle (fine adjustment is performed). Further, the second steer angle is a steer angle larger than the first steer angle, by which the front wheels 13 are turned.

The small steer-angle adjustment arm 11 is arranged so as to be located on the rear side of the vehicle with respect to the dial 8 when the dial 8 is in the neutral position. When the first steer angle is to be applied to the front wheels 13, the small steer-angle adjustment arm 11 may be used. A shape of the small steer-angle adjustment arm 11 may be the same as those of the first arm 9 and the second arm 10. In the first embodiment in which the arms 9, 10, and 11 have the same shape, the arms 9, 10, and 11 are arranged equiangularly (at 120-degree pitches) in the circumferential direction. The arms 9, 10, and 11 have the same length and the same height (position in the x-axis direction). Balls 21, 22, and 23 are mounted to distal ends of the arms 9, 10, and 11, respectively. The balls 21, 22, and 23 have the same shape, and are each formed in a size that allows the ball to be gripped by the driver with his/her fingers (for example, about 28 mm). A length of each of the arms 9, 10, and 11 in the radial direction is set to, for example, from 40 mm to 50 mm.

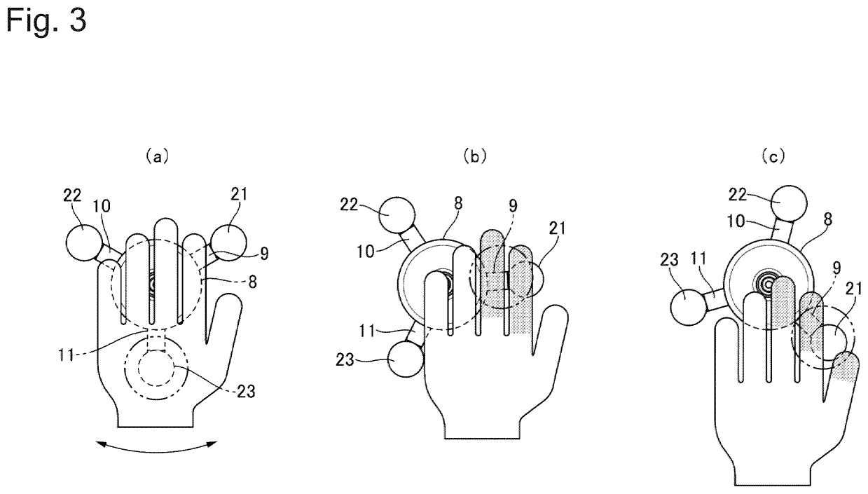

FIG. 3 are views for illustrating a method of operating the steering-operation input member 2 according to the first embodiment.

As illustrated in FIG. 3(a), at the time of straight-ahead running and at the time of a steering operation for applying the first steer angle to the front wheels 13 (at the time of a small steer-angle operation), the dial 8 or the rear ball 23 is operated. The dial 8 is operated through the rotation of a wrist, and the rear ball 23 is operated through the rightward and leftward motions of the wrist. At this time, when fingers are put on and positioned for engagement with a front side of the dial 8 between the first arm 9 and the second arm 10, the driver can prepare for switching to a middle steer-angle operation described later.

As illustrated in FIG. 3(b), at the time of a steering operation for applying the second steer angle to the front wheels 13 (at the time of the middle steer-angle operation), the fingers in a waiting state are moved from the state of FIG. 3(a) onto the first arm 9 or the second arm 10 so that a pulling operation is performed on the first arm 9 or the second arm 10 with two fingers. In a case of rightward steering, a pulling operation is performed on the first arm 9 with the index finger and the middle finger. In a case of leftward steering, a pulling operation is performed on the second arm 10 with the ring finger and the little finger.

As illustrated in FIG. 3(c), when the second steer angle is to be applied to the front wheels 13, that is, at the time of a steering operation for applying a further larger steer angle (at the time of a large steer-angle operation), the right ball 21 of the first arm 9 or the left ball 22 of the second arm 10 is gripped so that a pulling operation is performed thereon from the state of FIG. 3(b).

Next, functions and effects of the first embodiment are described.

As a new maneuvering device that replaces a related-art steering wheel, there has been known a dial type steering device. However, a grip position on the dial cannot be changed. Thus, it is inevitable to set an operation angle range narrow. When a steering gear ratio is set high or large, vehicle behavior becomes sensitive to the steering operation. Hence, a certain level of driving proficiency is required. Further, when the grip position on the dial is changed, changing the grip position may affect vehicle behavior. Thus, operability is required to be improved.

Meanwhile, when the driver intends to perform the steering operation exceeding the range of motion of the wrist of the driver, the steering apparatus 1 according to the first embodiment allows the driver to move his/her hand to touch the second operating portion different from the first operating portion, with the result that the driver can continue the operation in an uninterrupted manner. As compared to a related-art case in which the operation is performed for the entire steer angle range only with the dial, the operation angle range can be set wider. As a result, the driver can use the first operating portion or the second operating portion interchangeably to perform the operation in accordance with a desired steer angle, while vehicle behavior is prevented from becoming sensitive to the steering operation. Hence, operability can be improved.

The first operating portion includes the dial 8 that is rotated about the shaft 18. The second operating portion includes the first arm 9 and the second arm 10, which are each subjected to a steering operation larger than that performed on the dial 8. The dial 8 enables easy fine adjustment in the small steer-angle operation range. Meanwhile, the first arm 9 and the second arm 10 enable a quick and stable operation in middle/large steer-angle operation ranges by using a plurality of fingers. Thus, the use of the dial 8, the arm 9, or the arm 10 in accordance with the degree of the steer angle enables the improvement of operability.

The dial 8 includes the placement portion 19 and the side surface portion 20. The placement portion 19 expands radially outward from the shaft 18, and allows a hand of the driver to be placed thereon. The side surface portion 20 extends in the x-axis direction from the radially outer side of the placement portion 19. The first arm 9 and the second arm 10 each extend radially outward from the dial 8. With this configuration, for the small steer-angle operation range, a hand is placed on the placement portion 19 so that the dial 8 can be operated through the rotation of the wrist in a comfortable position. Thus, operability is improved. Further, the fingers are put on the arms 9 and 10 extending from the dial 8 so as to prepare for switching to the middle steer-angle operation. Thus, smooth operation switching from a small steer angle to a middle/large steer angle is enabled to thereby improve operability.

The first arm 9 and the second arm 10 are arranged so as to be located at bilaterally symmetric positions with respect to the dial 8 when the dial 8 is in the neutral position. The arrangement of two arms 9 and 10 at equal distances from the dial 8 further improves operability.

The first operating portion may include the small steer-angle adjustment arm 11 extending radially outward from the dial 8. The small steer-angle adjustment arm 11 is arranged so as to be located on the rear side of the vehicle with respect to the dial 8 when the dial 8 is in the neutral position. With this arrangement, for the small steer-angle operation range, the wrist is placed on the small steer-angle adjustment arm 11 and the steering operation can be performed through the rightward and leftward motions of the wrist in a comfortable position. Thus, operability is improved.

The first arm 9, the second arm 10, and the small steer-angle adjustment arm 11 have the balls 21, 22, and 23, respectively, which can be gripped by the driver with his/her fingers. Thus, for the large steer-angle operation range, a large operation is enabled with a gripping operation on the right ball 21 or the left ball 22. Hence, the first arm 9 and the second arm 10 are easily rotated. Further, the grip position can be smoothly changed from that for the dial operation, and hence operability at the time of the large steer-angle operation can be improved. Further, for the small steer-angle adjustment arm 11, the presence of the rear ball 23 allows easier placement of the wrist and allows the wrist to be kept thereon. Accordingly, fine adjustment through the operation with the wrist is further facilitated.

### Second Embodiment

A basic configuration according to a second embodiment is the same as that according to the first embodiment. Thus, only a difference from the first embodiment is described.

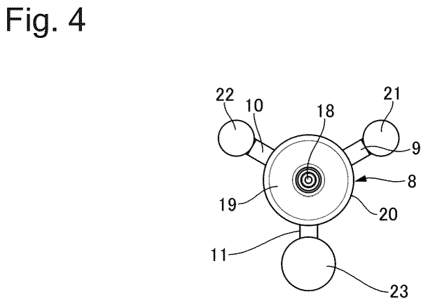

FIG. 4 is a view of a steering-operation input member 2 according to the second embodiment when viewed from above.

The steering-operation input member 2 according to the second embodiment is different from the steering-operation input member according to the first embodiment in that a rear ball 23 has a diameter larger than those of a right ball 21 and a left ball 22. The first ball 21 and the second ball 22 have the same shape.

In the second embodiment, the right ball 21 of the first arm 9 and the left ball 22 of the second arm 10 are distinguished from the rear ball 23 of the small steer-angle adjustment arm 11. As a result, the neutral position of the steering-operation input member 2 can easily be recognized in an intuitive manner. Further, the larger diameter of the rear ball 23 allows easy placement of the wrist on the rear ball 23, making it easier to keep the wrist thereon.

### Third Embodiment

A basic configuration according to a third embodiment is the same as that according to the first embodiment. Thus, only a difference from the first embodiment is described.

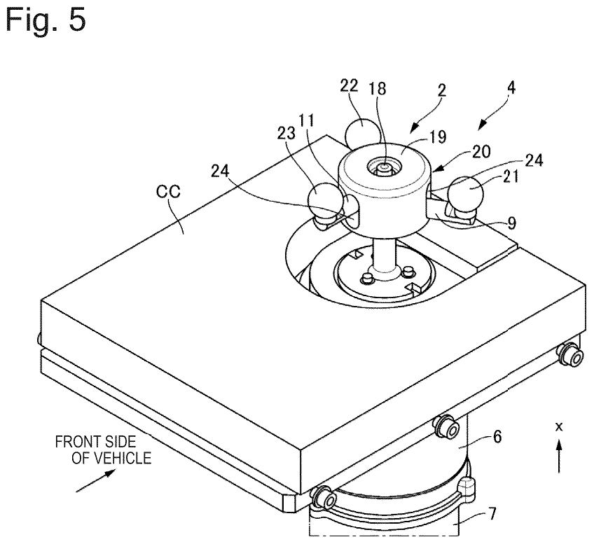

FIG. 5 is a perspective view of a steering-operation input member 2 according to the third embodiment when viewed from the right rear of a vehicle.

The steering-operation input member 2 according to the third embodiment differs from the steering-operation input member according to the first embodiment in that arms 9, 10, and 11 can be set at any appropriate positions in the x-axis direction. Elongated holes 24, each extending in the x-axis direction, are formed in a side surface portion 20 of a dial 8 at positions corresponding to the arms 9, 10, and 11. The position of each of the arms 9, 10, and 11 in the x-axis direction can be appropriately set within a predetermined range (range of a length of the elongated hole 24) with respect to the dial 8. In the third embodiment, the small steer-angle adjustment arm 11 is set on the x-axis positive side (vertically upper side) with respect to the first arm 9 and the second arm 10.

In the steering-operation input member 2 according to the third embodiment, mounting positions of balls 21, 22, and 23 in the x-axis direction can be appropriately changed, and hence each of the balls 21, 22, and 23 can be set at a desired height for each driver. Thus, operability can be improved.

The rear ball 23 according to the third embodiment is positioned vertically above the right ball 21 and the left ball 22. Thus, the right ball 21 of the first arm 9 and the left ball 22 of the second arm 10 are distinguished from the rear ball 23 of the small steer-angle adjustment arm 11. As a result, the neutral position of the steering-operation input member 2 can easily be recognized in an intuitive manner. Further, when the rear ball 23 is set on the x-axis direction side (vertically upper side) with respect to a placement portion 19, the wrist can easily be placed on the rear ball 23, making it easier to keep the wrist thereon.

### Fourth Embodiment

A basic configuration according to a fourth embodiment is the same as that according to the first embodiment. Thus, only a difference from the first embodiment is described.

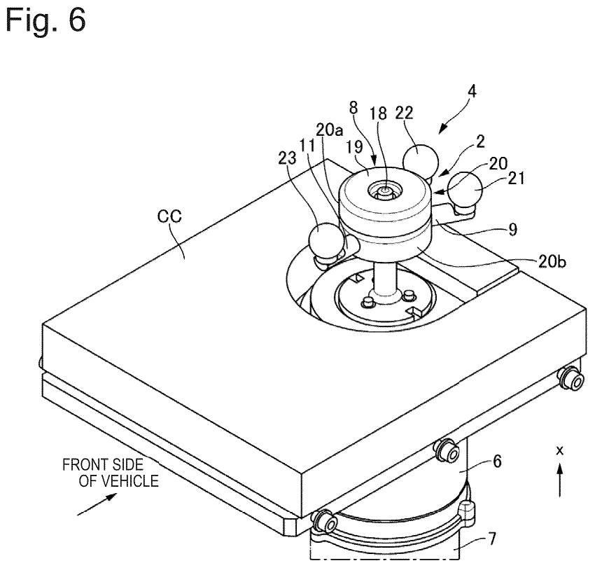

FIG. 6 is a perspective view of a steering-operation input member 2 according to the fourth embodiment when viewed from the right rear of a vehicle.

The steering-operation input member 2 according to the fourth embodiment differs from the steering-operation input member according to the first embodiment in that arms 9. 10, and 11 are not arranged equiangularly (at 120-degree pitches) in the circumferential direction. The arms 9, 10, and 11 have the same shape, and balls 21, 22, and 23 have the same shape.

The first arm 9 and the second arm 10 are arranged so as to be located at bilaterally symmetric positions with respect to a dial 8 when the dial 8 is in the neutral position. However, the positions of arrangement thereof are different. The arms are arranged in such a manner that, when center points of the balls 21, 22, and 23 are connected to each other, an isosceles triangle is formed in a plane containing the three center points.

In the fourth embodiment, the neutral position of the steering-operation input member 2 can easily be recognized in an intuitive manner by changing the positions of arrangement of the first arm 9 and the second arm 10. Further, for example, when a hand of the driver is placed on a placement portion 19, the fingers of the driver can be put on and positioned for engagement with both of the first arm 9 and the second arm 10. In this case, the first arm 9 and the second arm 10 are constantly kept in contact with the fingers of the driver regardless of a position of the wrist of the driver. Thus, a direction in which the steering-operation input member 2 is directed (the amount of operation applied thereto) can easily be recognized in an intuitive manner. Thus, a direction in which the vehicle is travelling can be recognized.

A basic configuration according to a fifth embodiment is the same as that according to the first embodiment. Thus, only a difference from the first embodiment is described.

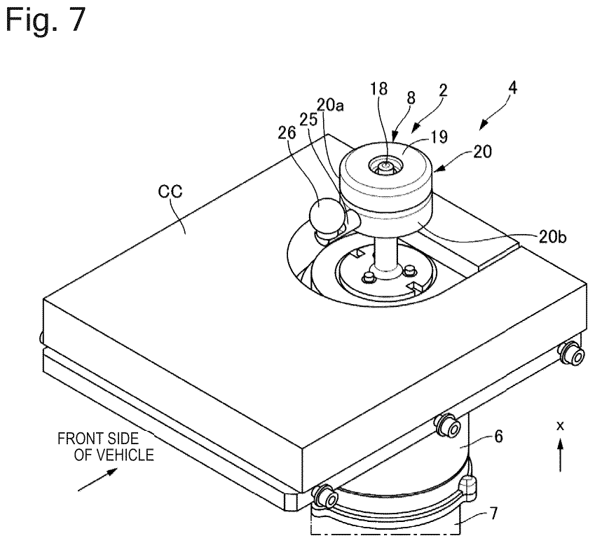

FIG. 7 is a perspective view of a steering-operation input member 2 according to the fifth embodiment when viewed from the right rear of a vehicle.

The steering-operation input member 2 according to the fifth embodiment includes a dial 8 corresponding to a first operating portion and a third arm 25 corresponding to a second operating portion. The third arm 25 is arranged so as to be located on the rear side of a vehicle with respect to the dial 8 when the dial 8 is in the neutral position. A rear ball 26 is mounted to a distal end of the third arm 25. The rear ball 26 is formed in a size that allows the rear ball 26 to be gripped by a driver with his/her fingers.

A method of operating the steering-operation input member 2 according to the fifth embodiment is now described. At the time of straight-ahead running and at the time of the small steer-angle operation, the dial 8 is rotationally operated as in the first embodiment. At the time of the middle steer-angle operation, for example, the thumb is put on the third arm 25 and performs a pushing operation thereon to thereby rotate the third arm 25. At the time of the large steer-angle operation, the rear ball 26 is gripped to rotate the third arm 25. Thus, when a driver intends to perform the steering operation exceeding the range of motion of the wrist of the driver, the driver moves his/her hand to touch the second operating portion different from the first operating portion, with the result that the driver can continue the operation in an uninterrupted manner. Further, as compared to a related-art case in which the operation is performed for the entire steer-angle region only with the dial, the operation angle range is set wider. As a result, the driver can use the first operating portion or the second operating portion to perform the operation in accordance with a desired steer angle, while vehicle behavior is prevented from becoming sensitive to the steering operation. Thus, operability can be improved.

### Other Embodiments

The embodiments of the present invention have been described above. However, the specific configuration of the present invention is not limited to the configuration described in each of the embodiments. A change in design without departing from the scope of the gist of the invention is also encompassed in the present invention.

For example, in the first embodiment, the steering-operation input device is installed in the center console. However, the steering-operation input device may be installed at any appropriate position as long as a driver can operate the steering-operation input device.

The placement portion of the dial may have a protruding shape

The following configuration may also be used. When a driver is operating the dial, only the upper member of the side surface portion is rotated with respect to the shaft. When a driver is operating the arm, the upper member and the lower member are rotated integrally with respect to the shaft.

Each of the balls may be configured to be rotatable about a rotation axis being parallel to the rotary shaft of the dial with respect to the arm.

Further, the first arm 9, the second arm 10, the small steer-angle adjustment arm 11, and the third arm 25 may each be extended in any appropriate direction. In the embodiments described above, in particular, the small steer-angle adjustment arm 11 and the third arm 25 are extended to the rear side of the vehicle with respect to the dial 8. However, the small steer-angle adjustment arm 11 and the third arm 25 may be extended to a front side of the vehicle with respect to the dial 8. In this case, a traveling direction of the vehicle at the time of small steering is easily recognized.

Note that, the present invention is not limited to the embodiments described above, and includes further various modification examples. For example, in the embodiments described above, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, or replace a part of the configuration of each of the embodiments.

The present application claims a priority based on Japanese Patent Application No. 2022-193901 filed on Dec. 5, 2022. All disclosed contents including Specification, Scope of Claims, Drawings, and Abstract of Japanese Patent Application No. 2022-193901 filed on Dec. 5, 2022 are incorporated herein by reference in their entirety.

### REFERENCE SIGNS LIST

1 . . . steering apparatus, 2 . . . steering-operation input member, 3 . . . rack bar (turning shaft), 4 . . . steering-operation input device, 7 . . . steering ECU (output unit), 8 . . . dial (first operating portion), 9 . . . first arm (second operating portion), 10 . . . second arm (second operating portion), 11 . . . small steer-angle adjustment arm, 13 . . . front wheel (wheel), 15 . . . turning motor (turning actuator), 18 . . . shaft (rotary shaft), 19 . . . placement portion, 20 . . . side surface portion, 21 . . . right ball, 22 . . . left ball, 23 . . . rear ball

1. A steering-operation input member to which a steering operation performed by a driver is to be input, the steering-operation input member comprising:
a rotary shaft configured to be rotated about an axis thereof;
a first operating portion provided to the rotary shaft; and
a second operating portion, which is connected to the rotary shaft and has a different length from a rotation center of the rotary shaft with respect to the first operating portion.

2. The steering-operation input member according to claim 1,
wherein the first operating portion is subjected to a steering operation when a first steer angle is to be applied to the wheel, and
wherein the second operating portion is subjected to a steering operation when a second steer angle larger than the first steer angle is to be applied to the wheel.

3. The steering-operation input member according to claim 2,
wherein the first operating portion includes a dial configured to be rotated about the rotary shaft, and
wherein the second operating portion includes a first arm and a second arm, which are each subjected to a steering operation larger than a steering operation performed on the dial.

4. The steering-operation input member according to claim 3,
wherein, when a direction extending along the rotary shaft is defined as an axial direction, the dial includes:
a placement portion, which expands outward from the rotary shaft in a radial direction of the rotary shaft and allows a hand of the driver to be placed on the placement portion; and
a side surface portion extending in the axial direction from an outer side of the placement portion in the radial direction, and
wherein the first arm and the second arm each extend outward in the radial direction from the dial.

5. The steering-operation input member according to claim 4, wherein the first arm and the second arm are arranged so as to be located at bilaterally symmetric positions with respect to the dial when the dial is in neutral position.

6. The steering-operation input member according to claim 3,
wherein the first operating portion includes a small steer-angle adjustment arm extending outward in the radial direction from the dial, and
wherein the small steer-angle adjustment arm is arranged so as to be located on a rear side of the vehicle with respect to the dial when the dial is in neutral position.

7. The steering-operation input member according to claim 5, wherein the first arm, the second arm, and the small steer-angle adjustment arm each have a ball that is grippable by the driver with his/her fingers.

8. The steering-operation input member according to claim 7, wherein a mounting position of the ball in the axial direction is appropriately changeable.

9. The steering-operation input member according to claim 8,
wherein, when the placement portion side of the dial is defined as an upper side and a side opposite to the placement portion is defined as a lower side in the axial direction, the ball of the small steer-angle adjustment arm is positioned above the ball of the first arm and the ball of the second arm in the axial direction.

10. The steering-operation input member according to claim 7, wherein the ball of the small steer-angle adjustment ball has an outer diameter larger than an outer diameter of the ball of the first arm and an outer diameter of the ball of the second arm.

11. The steering-operation input member according to claim 1,
wherein the first operating portion can be gripped while a palm of the driver is kept in contact with the rotary shaft, and
wherein the second operating portion is provided at a position separated apart from the first operating portion and allows the steering operation to be performed with fingers of the driver.

12. A steering-operation input device, comprising:
a steering-operation input member to which a steering operation performed by a driver is to be input; and
an output unit configured to output a turning command to a turning actuator configured to turn a wheel of a vehicle based on an operation amount of the steering-operation input member,
wherein the steering-operation input member comprises:
a rotary shaft configured to be rotated about an axis thereof;
a first operating portion provided to the rotary shaft; and
a second operating portion, which is connected to the rotary shaft and has a different length from a rotation center of the rotary shaft with respect to the first operating portion.

13. A steering apparatus of a steer-by-wire system in which a steering-operation input member to which a steering operation performed by a driver is to be input and a turning shaft configured to turn a wheel of a vehicle are mechanically separated from each other,
wherein the steering-operation input member comprises:
a rotary shaft configured to be rotated about an axis thereof;
a first operating portion provided to the rotary shaft; and
a second operating portion, which is connected to the rotary shaft and has a different length from a rotation center of the rotary shaft with respect to the first operating portion.

14. The steering-operation input member according to claim 6, wherein the first arm, the second arm, and the small steer-angle adjustment arm each have a ball that is grippable by the driver with his/her fingers.

15. The steering-operation input member according to claim 14, wherein a mounting position of the ball in the axial direction is appropriately changeable.

16. The steering-operation input member according to claim 15,
wherein, when the placement portion side of the dial is defined as an upper side and a side opposite to the placement portion is defined as a lower side in the axial direction, the ball of the small steer-angle adjustment arm is positioned above the ball of the first arm and the ball of the second arm in the axial direction.

17. The steering-operation input member according to claim 14, wherein the ball of the small steer-angle adjustment ball has an outer diameter larger than an outer diameter of the ball of the first arm and an outer diameter of the ball of the second arm.
